(19) United States
(12) Patent Application Publication
(10) Pub. No.: US 2014/0268798 A1
(43) Pub. Date: Sep. 18, 2014

(54) LED BAY LIGHT

(71) Applicants: CPUMATE INC., New Taipei City (TW); GOLDEN SUN NEWS TECHNIQUES CO., LTD., New Taipei City (TW)

(72) Inventors: KUO-JEN LIN, NEW TAIPEI CITY (TW); CHIH-HUNG CHENG, NEW TAIPEI CITY (TW); WEN-JUNG LIU, NEW TAIPEI CITY (TW)

(73) Assignees: GOLDEN SUN NEWS TECHNIQUES CO., LTD., NEW TAIPEI CITY (TW); CPUMATE INC., NEW TAIPEI CITY (TW)

(21) Appl. No.: 13/831,961

(22) Filed: Mar. 15, 2013

(51) Int. Cl. F21V 29/00

(52) U.S. Cl. CPC F21V 29/2212
USPC 362/294

(57) ABSTRACT

An LED bay light includes a heat pipe module, a light condenser and at least one LED light emitting module. The heat pipe module is coupled to a side of the light condenser, and both are made of a thermally conductive material. The light condenser includes a top plate and at least one reflecting plate. The LED light emitting module is installed on a side of the top plate and covered by an inner side of the reflecting plate, and the inner side of the reflecting plate is coated with a color layer. The LED bay light dissipates heat produced from the LED light emitting module by the heat pipe module and the light condenser simultaneously to improve the heat dissipation efficiency effectively, and the light of the LED bay light can change its color through the reflection from the reflecting plate or the color layer.

### BACKGROUND OF THE INVENTION

1. Field of the Invention

The present invention relates to the area of LED illumination lights, and more particularly to the LED bay light that is combined with a heat pipe module and a light condenser to faun a two-stage heat dissipating structure for improving the effect of dissipating the quantity of heat produced by the illumination of the light significantly, and the light can be switched to an illumination color by changing the color of the reflecting plate in order to change environmental scenarios.

2. Description of the Related Art

Since Light Emitting Diodes (LED) has the features of high efficiency, power saving, long life, cold luminescence, quick response and consistent color, therefore the LED has gradually replaced the traditional light sources and is used extensively in illumination in recent years. As the LED illumination light is applied for a higher power of illumination such as its application in dense LED lights including embedded lights and bay lights, a large quantity of heat is accumulated during their application, thus shortening the service life of the LED significantly and reducing the light emission performance of the illumination.

In general, the bay light is hanged for its use in large venues such as factories, market warehouse, parking lots, gas stations, stadiums and underpasses, and the bay light mainly includes an inverted bowl shaped lampshade and a light emitting lamp, wherein the inner wall of the inverted bowl shaped lampshade has a surface of a specific curvature for collecting and projecting the light source emitted from the light emitting lamp to the outside, so that the light will be not excessively attenuated after it is projected through a long distance. The bay light made of high power LEDs, which is also known as LED bay light refers to the LED illumination lamp with a power falling within a range of 70 W-260 W. The use of high power is accompanied with a relatively large quantity of heat, and thus resulting in a shorter service life of the LED and a lower light emission performance of the illumination. Obviously, it is very important to assure a good heat dissipation effect for the use of the bay light.

At present, there are several heat dissipation methods as described below. The common method is to use a thermally conductive material such as aluminum alloy or copper alloy as a conductor to be attached directly to a circuit substrate of an LED, and the conductor has a plurality of fins installed thereon. During use, a quantity of heat is conducted to the fins by conduction and then dissipated to the outside through the fins. Since the LED bay light produces a very large quantity of heat, therefore a fan is installed on a side of the fins, so as to force the outside air to enter into the fins and dissipate the large quantity of heat effectively and quickly.

Although the LED bay light with the heat dissipating structure has a good heat dissipation effect, yet such LED bay light has the shortcomings of large volume, heavy weight and additional power supply for the fan. Therefore, it is an important subject for related manufacturers to develop an LED bay light with small volume, light weight, good illumination and heat dissipation effects to overcome the shortcomings of the conventional LED bay light.

### SUMMARY OF THE INVENTION

In view of the problems of the prior art, it is a primary objective of the present invention to provide an LED bay light with a small volume and a high illumination efficiency, and the LED light emitting module is combined by a heat pipe module and a light condenser, wherein the heat pipe module and the light condenser are provided for dissipating the heat produced by the LED bay light simultaneously and dissipating the heat generated by the LED light emitting module, so as to take both illumination effect and service life into consideration at the same time.

Another objective of the present invention is to provide an LED bay light, wherein the light condenser is composed of a top plate and at least one reflecting plate, and a color layer is disposed on an inner side of the reflecting plate and aligned in a direction corresponding to the direction of emitting lights from the LED light emitting module, so that after the light is reflected, a light with a color corresponding to the color of the color layer is produced to change environmental scenarios.

A further objective of the present invention is to provide an LED bay light with a convenience assembling and installation, and the reflecting plate used in the light condenser can be assembled by a screwing, snapping or embedding method to facilitate the repair and maintenance of the LED bay light, so as to reduce the maintenance and using costs.

To achieve the aforementioned objectives, the present invention provides an LED bay light, comprising: a heat pipe module, further comprising: a base; a plurality of heat conducting pipes, installed along the base; and a fin set, having a plurality of fins installed with an interval apart from one another on the heat conducting pipes to form a plurality of first diversion passages in the horizontal direction, and each fin having at least one ventilation hole to form a second diversion passage in the vertical direction, and a predetermined interval being maintained between a bottom of the fin set and the base for guiding a heat current to the second diversion passage; a light condenser, installed on a side of the heat pipe module, and further comprising: a top plate, with a side coupled to the base; and at least one reflecting plate, installed around periphery of the top plate to form a cover structure, and a reflecting surface formed on an inner side of the reflecting plate; and at least one LED light emitting module, installed on the other side of the top plate, such that the LED light emitting module is covered within the reflecting plate; when use, a quantity of heat produced by the LED light emitting module is conducted to the heat pipe module and the reflecting plate through the top plate for heat dissipation.

To facilitate the manufacture, the base and the top plate are integrally formed and manufactured, or the top plate and the reflecting plate are integrally formed and manufactured, or the base, the top plate and the reflecting plate are integrally formed and manufactured. Such arrangement requires no additional assembling steps, and also enhances the original conduction effect for the heat dissipation, so as to prevent a low heat dissipation efficiency caused by the thermal resistance at the interfaces.

To facilitate the assembling process, if more than one reflecting plates are used, the reflecting plates are coupled to each other through their edges, and the reflecting plates are assembled by a screwing, snapping and embedding method.

In a preferred embodiment of the present invention, the LED bay light further comprises a color layer coated onto the reflecting surface, such that after a light of the LED light emitting module is passed through the color layer and reflected, a light with the corresponding color is produced. For example, a yellow or red light can give a warm feeling, and a blue light can give a cool feeling.

To improve the heat dissipation efficiency, the LED bay light of the present invention further comprises a heat sink installed between the base and the top plate for conducting a quantity of heat to the heat sink to disperse a portion of the heat first, and the remaining portion of the heat is conducted to the base.

In another preferred embodiment, the LED bay light of the present invention comprises: a heat pipe module, further comprising a base; a plurality of heat conducting pipes, installed along the base; and a fin set, having a plurality of fins installed with an interval apart from one another on the heat conducting pipes to form a plurality of first diversion passages in the horizontal direction, and each fin having at least one ventilation hole to form a second diversion passage in the vertical direction, and a predetermined interval being maintained between the bottom of the fin set and the base for guiding a heat current to the second diversion passage; a light condenser, installed on a side of the heat pipe module, and comprising: a top plate, having an opening farmed at the center of the top plate corresponding to the base and install the base therein; and at least one reflecting plate, installed around the periphery of the top plate to form a cover structure, and a reflecting surface formed on an inner side of the reflecting plate; and at least one LED light emitting module, installed on a side of the base, such that the LED light emitting module is covered within the reflecting plate; when use, a quantity of heat produced by the LED light emitting module is conducted to the base directly and dissipated to the outside through the heat pipe module and the reflecting plate.

### BRIEF DESCRIPTION OF THE DRAWINGS

FIG. 1 is a schematic view of a preferred embodiment of the present invention;

FIG. 2 is a cross-sectional view of a preferred embodiment of the present invention;

FIG. 3A shows a first implementation mode of a light condenser of a preferred embodiment of the present invention;

FIG. 3B is a partial blow-up view of a FIG. 3A;

FIG. 3C is a partial blow-up view of a FIG. 3A;

FIG. 4A shows a second implementation mode of a light condenser of a preferred embodiment of the present invention;

FIG. 4B is a partial blow-up view of a FIG. 4A;

FIG. 4C is a partial blow-up view of a FIG. 4A;

FIG. 5A shows a third implementation mode of a light condenser of a preferred embodiment of the present invention;

FIG. 5B is a partial blow-up view of a FIG. 5A;

FIG. 6 is a schematic view of another preferred embodiment of the present invention; and

FIG. 7 is a cross-sectional view of the other preferred embodiment of the present invention.

### DETAILED DESCRIPTION OF THE PREFERRED EMBODIMENTS

The technical content of the present invention will become apparent with the detailed description of preferred embodiments and the illustration of related drawings as follows.

With reference to FIGS. 1 to 5 for a schematic view, a cross-sectional view, a partial blow-up view and three implementation modes of an LED bay light 1 in accordance with a preferred embodiment of the present invention respectively, the LED bay light 1 comprises a heat pipe module 11, a light condenser 12 and an LED light emitting module 13, and the LED bay light 1 is hanged under a ceiling of a large venue to provide the required illumination effect.

Wherein, the heat pipe module 11 comprises a base 111, a plurality of heat conducting pipes 112 and a fin set 113. The base 111 is made of a thermally conductive material and has a plurality of containing slots 1111 formed in the middle of the base 111, disposed at positions corresponding to the heat conducting pipes 112 respectively, and arranged parallel to one another. The heat conducting pipes 112 are U-shaped, and the central position of each heat conducting pipe 112 is disposed in the containing slot 1111, and both ends of the heat conducting pipe 112 are extended upwardly. The fin set 113 includes a plurality of fins 1131, and each fin 1131 has a plurality of through holes 11311 corresponding to both ends of the heat conducting pipes 112 and installed with an interval apart from one another on the heat conducting pipes 112, such that a plurality of first diversion passages 1132 in the horizontal direction are formed between the fins 1131, and the central position of each fin 1131 has a substantially rectangular shaped ventilation hole 1133. After the fins 1131 are assembled, a second diversion passage 1134 is formed in the vertical direction, and a predetermined interval is maintained between a bottom of the fin set and the base for guiding a heat current to the second diversion passage. It is noteworthy that the shape of the ventilation hole 1133 is not limited to the rectangular shape only, but it also can be in a circular shape, a polygonal shape, or any other irregular geometric shape, and the size of the ventilation hole 1133 of each fin 1131 can be the same or different, so that cross-sectional shape of the second diversion passage 1134 can be of the same width, or upwardly tapered, or downwardly tapered.

The light condenser 12 is installed on a side of the heat pipe module 11, and the light condenser 12 includes a top plate 121 and a reflecting plate 122, wherein the top plate 121 is made of a thermally conductive material, and a side of the top plate 121 is coupled to the base 111. It is noteworthy that the base 111 and the top plate 121 can be integrally formed and manufactured to improve the heat dissipation effect.

In addition, a heat sink 14 is installed between the base 111 and the top plate 121 for improving the heat dissipation efficiency. When the heat is conducted from the top plate 121 to the heat sink 14, a portion of the heat is dispersed first, and the remaining quantity of heat is conducted to the base 111 and dissipated by the heat pipe module 11.

The reflecting plate 122 is a circular cover structure made of a thermally conductive material, and the top of the reflecting plate 122 has an upper opening 1221 corresponding to the top plate 121, and the bottom of the reflecting plate 122 has a lower opening 1222 with a diameter much greater than the diameter of the upper opening 1221, and the top plate 121 is disposed around the periphery of the reflecting plate 122 through the upper opening 1221, and a reflecting surface 1223 is formed on an inner side of the reflecting plate 122. In addition, a color layer 1224 is coated onto the reflecting surface 1223. To improve the heat dissipation effect, the reflecting plate 122 and the top plate 121 can be integrally formed and manufactured, or the reflecting plate 122, the top plate 121 and the base 111 can be integrally formed and manufactured.

The LED light emitting module 13 is installed on the other side of the top plate 121, such that the LED light emitting module 13 is covered within the reflecting plate 122. When use, the heat produced by the LED light emitting module 13 is conducted to the heat pipe module 11 and the reflecting plate 122 through the top plate 121 and dissipated. In addition, after the light of the LED light emitting module 13 is passed through the color layer 1224 and reflected, a light with the corresponding color is produced.

To facilitate the hanging of the LED bay light and consider the heat dissipation effect at the same time, a protective net 15 is wrapped onto the exterior of the heat pipe module 11, and a hanging frame 16 is mounted onto the exterior of the protective net 15 and coupled to the top plate 121, and extended upwardly to wrap the protective net 15, and a hanging ring 161 is installed at the top of the hanging frame 16.

If more than one reflecting plates 122 are adopted, each reflecting plate 122 has a corresponding structure at its edge, so that the edges can be coupled with each other for the assembling process. The assembling method can be a screwing, snapping or embedding method. In FIG. 3, the top plate 121 has a plurality of fixing holes arranged in a rectangular shape corresponding to four reflecting plates, and four reflecting plates 122 are installed at the fixing holes of the top plate 121 respectively, and each reflecting plate 122 is in the shape of a trapezium (or an upwardly tapered shape) whose bevels have a folded plate 1225 each, and the folded plate 1225 has a plurality of screw holes 1226 formed thereon. During the assembling process, the reflecting plates 122 are coupled and the folded plates 1225 are engaged, and screws are used for screwing or rivets are used for riveting. Finally, the reflecting plates 122 are assembled and fixed to the periphery of the top plate 121. In FIG. 4, the quantity and the shape of the reflecting plates 122 are the same as those of the previous implementation mode, but each reflecting plate 122 has a plurality of latch holes 1227 formed on a bevel, and a plurality of latch parts 1228 formed on the other bevel and corresponding to the latch holes 1227. During the assembling process, the latch parts 1228 are latched into the latch holes 1227 respectively to complete the assembly. In FIG. 5, the quantity and the shape of the reflecting plates 122 are the same as those of the previous implementation mode, but each reflecting plate 122 has a plurality of embedding bars 1229 formed on a bevel, and a plurality of embedding slots 12210 formed on the other bevel and corresponding to the embedding bars 1229 respectively, During the assembling process, the embedding bars 1229 are snapped into the embedding slots 12210 to complete the assembly.

With reference to FIGS. 6 and 7 for a schematic view and a cross-sectional view of an LED bay light 2 in accordance with another preferred embodiment of the present invention respectively, the LED bay light 2 also comprises a heat pipe module 21, a light condenser 22 and an LED light emitting module 23.

Wherein, the heat pipe module 21 has the same structure of the previous preferred embodiment comprising a base 211, a plurality of heat conducting pipes 212 and a fin set 213, and the assembling process is also the same, and thus will not be repeated.

Similarly, the light condenser 22 is installed on a side of the heat pipe module 21 and includes a top plate 221 and a reflecting plate 222, and the biggest difference resides on that an opening 2211 is formed at the center of the top plate 221 and disposed at a position corresponding to the base 211 for embedding the base 211 into the opening 2211. The reflecting plate 222 is disposed around the periphery of the top plate 211 to form a cover structure, and a reflecting surface 2221 is formed on an inner side of the reflecting plate 222, and a color layer 2222 is coated onto the reflecting surface 2221. It is noteworthy that the top plate 221 and the reflecting plate 222 can be integrally formed and manufactured.

The LED light emitting module 23 is installed on a side of the base 211, such that the heat produced by the LED light emitting module 13 is conducted to the base 211 and dissipated to the outside through the heat pipe module 21 and the reflecting plate 222.

In summation, after the LED bay lights 1, 2 of the present invention are electrically coupled to a power supply and the power supply is turned on, the reflecting plates 122, 222 with different color layers 1224, 2222, or the color layers 1224, 2222 on the reflecting plates 122, 222 drive the LED light emitting modules 13, 23 of the LED bay lights 1, 2 to be lit, and the light with the corresponding color can be emitted and projected to the outside through the reflecting plates 122, 222 to provide the lighting for the required environmental scenario. For example, a yellow or red light can give a warm feeling, and a blue light can give a cool feeling.

What is claimed is:

1. An LED bay light, comprising:
a heat pipe module, further comprising:
a base;
a plurality of heat conducting pipes, installed along the base; and
a fin set, having a plurality of fins installed with an interval apart from one another on the heat conducting pipes to form a plurality of first diversion passages in the horizontal direction, and each fin having at least one ventilation hole to form a second diversion passage in the vertical direction, and a predetermined interval being maintained between a bottom of the fin set and the base for guiding a heat current to the second diversion passage;
a light condenser, installed on a side of the heat pipe module, and further comprising:
a top plate, with a side coupled to the base; and
at least one reflecting plate, installed around periphery of the top plate to farm a cover structure, and a reflecting surface formed on an inner side of the reflecting plate; and
at least one LED light emitting module, installed on the other side of the top plate, such that the LED light emitting module is covered within the reflecting plate; when use, a quantity of heat produced by the LED light emitting module is conducted to the heat pipe module and the reflecting plate through the top plate for heat dissipation.

2. The LED bay light of claim 1, further comprising a heat sink installed between the base and the top plate.

3. The LED bay light of claim 1, wherein the base and the top plate are integrally formed and manufactured.

4. The LED bay light of claim 3, further comprising a heat sink installed between the base and the top plate.

5. The LED bay light of claim 1, wherein the top plate and the reflecting plate are integrally formed and manufactured.

6. The LED bay light of claim 5, further comprising a heat sink installed between the base and the top plate.

7. The LED bay light of claim 1, wherein the base, the top plate and the reflecting plate are integrally formed and manufactured.

8. The LED bay light of claim 1, wherein if the reflecting plate comes with a plural quantity, the reflecting plates are coupled to each other by connecting edges of the reflecting plates.

9. The LED bay light of claim 8, further comprising a color layer coated onto the reflecting surface, such that after a light of the LED light emitting module is passed through the color layer and reflected, a light with the corresponding color is produced.

10. The LED bay light of claim 9, wherein the reflecting plates are assembled by a method selected from the collection of screwing, snapping and embedding.

11. The LED bay light of claim 9, further comprising a color layer coated onto the reflecting surface, such that after a light of the LED light emitting module is passed through the color layer and reflected, a light with the corresponding color is produced.

12. The LED bay light of claim 11, further comprising a heat sink installed between the base and the top plate.

13. An LED bay light, comprising:
a heat pipe module, comprising:
a base;
a plurality of heat conducting pipes, installed along the base; and
a fin set, having a plurality of fins installed with an interval apart from one another on the heat conducting pipes to form a plurality of first diversion passages in the horizontal direction, and each fin having at least one ventilation hole to form a second diversion passage in the vertical direction, and a predetermined interval being maintained between a bottom of the fin set and the base for guiding a heat current to the second diversion passage;
a light condenser, installed on a side of the heat pipe module, and comprising:
a top plate, having an opening formed at the center of the top plate, and installed in the base; and
at least one reflecting plate, installed around periphery of the top plate to form a cover structure, and a reflecting surface formed on an inner side of the reflecting plate; and
at least one LED light emitting module, installed on a side of the base, such that the LED light emitting module is covered within the reflecting plate; when use, a quantity of heat produced by the LED light emitting module is conducted to the base directly and dissipated to the outside through the heat pipe module and the reflecting plate.

14. The LED bay light of claim 13, wherein the top plate and the reflecting plate are integrally formed and manufactured.

15. The LED bay light of claim 14, further comprising a color layer coated onto the reflecting surface, such that after a light of the LED light emitting module is passed through the color layer and reflected, a light with the corresponding color is produced.

16. The LED bay light of claim 13, wherein if the reflecting plate comes with a plural quantity, the reflecting plates are coupled to each other by connecting edges of the reflecting plates.

17. The LED bay light of claim 16, wherein the reflecting plates are assembled by a method selected from the collection of screwing, snapping and embedding.

18. The LED bay light of claim 16, further comprising a color layer coated onto the reflecting surface, such that after a light of the LED light emitting module is passed through the color layer and reflected, a light with the corresponding color is produced.
